(19) United States
(12) Patent Application Publication
(10) Pub. No.: US 2004/0030947 A1
(43) Pub. Date: Feb. 12, 2004

(54) Method and apparatus for testing simple object access protocol servers

(76) Inventors: Al Aghili, Boulder, CO (US); Peter Welter, Boulder, CO (US); John Meier, Longmont, CO (US)

Correspondence Address: PERKINS COIE LLP, P.O. BOX 2168, MENLO PARK, CA, 94026, US

(21) Appl. No.: 10/218,673

(22) Filed: Aug. 12, 2002

(51) Int. Cl. H02H 3/05; G06F 15/173

(52) U.S. Cl. 714/1; 709/224

(57) ABSTRACT

The present invention comprises, in one aspect, a method for testing a Simple Object Access Protocol (SOAP) server. According to one feature of the invention, a configuration file for testing is automatically formulated. A software application program tests the SOAP server based on the data in the configuration file. The SOAP server is thus tested repeatedly according to an automatic scheduling for the testing. In other aspects, the invention encompasses a computer apparatus, a computer readable medium, and a carrier wave configured to carry out the foregoing steps.

### FIELD OF THE INVENTION

The present invention generally relates to computer systems. The invention relates more specifically to a computer-implemented process of testing a Simple Object Access Protocol (SOAP) server.

### BACKGROUND OF THE INVENTION

The Internet is a robust Wide Area Network (WAN), which permits communication among computers, networks, and other digital devices, and which adhere to a standard “TCP/IP” protocol.

Users use their computers to access services that are provided by various web service providers. The users' computers that are used for accessing web services are herein referred to as client computers. Web services use Simple Object Access Protocol (SOAP), which is an eXtensible Markup Language (XML) based protocol for exchanging information over the Internet. Typically, the software that provides the web services resides on servers that also use SOAP. Such servers are herein referred to as SOAP servers.

For example, a SOAP server may offer a web service that performs a mathematical calculation for converting currency. An example of a client computer that would access a SOAP server that provides a web service for performing mathematical calculations related to currency conversion is a computer that runs accounting systems software. The accounting systems software may need to use the web service for currency conversion on a 24/7 basis. Thus, the SOAP server that provides the web service for currency conversion needs to operate without errors 24/7. It follows that SOAP servers need to be tested repetitively in order to detect and correct errors in the SOAP servers.

In one approach, an IT professional may manually test a given SOAP sever. However, because the testing of a given SOAP server is repetitive, the testing is better suited if performed automatically by a computer. Computers that perform testing of a given SOAP server are herein referred to as testing clients.

Thus, there is a need for a method to allow for automated testing of SOAP servers by testing clients.

### SUMMARY OF THE INVENTION

In one aspect, a method for testing a Simple Object Access Protocol (SOAP) server. According to one feature of the invention, a configuration file for testing is automatically formulated. A software application program tests the SOAP server based on the data in the configuration file for testing. The SOAP server is thus tested repetitively according to an automatic scheduling for the testing. In other aspects, the invention encompasses a computer apparatus, a computer readable medium, and a carrier wave configured to carry out the foregoing steps.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram that illustrates a computer system including the Internet, a number of user clients, a SOAP server, and a number of testing clients;

FIG. 2 is a flow diagram that illustrates a high level overview of one embodiment of a method for testing a SOAP server;

FIG. 3 is a flow diagram that illustrates the creation and editing of a monitor;

FIG. 4 is a flow diagram that illustrates the process for creating a configuration file for testing;

FIG. 5 is flow diagram that illustrates the process for editing and updating an existing monitor;

FIG. 6 is an illustration of a screen display of monitors in the SOAP group of FIG. 3;

FIG. 7 is an illustration of a blank form used in FIG. 4 to develop a configuration file for testing;

FIG. 8 is an illustration of a blank form used in FIG. 4 to develop a configuration file for testing;

FIG. 9A, FIGS. 9B and 9C illustrate a blank form used in FIG. 4 to develop a configuration file for testing;

FIG. 10 is an exemplary form of a configuration file for testing;

FIG. 11A and FIG. 11B illustrate a screen display of a request and response, and an XML formatted request and response;

FIG. 12 is a flow diagram that illustrates the process of testing a SOAP server by running a monitor of FIG. 2;

FIG. 13 is a flow diagram that illustrates the process for sending a sequence of SOAP requests to a SOAP server, of receiving corresponding responses from the SOAP server, and of analyzing the responses; and

FIGS. 14A-14C are sample reports that are generated by the GENERATE AND/OR DELIVER REPORT operation of FIG. 2.

### DETAILED DESCRIPTION OF THE PREFERRED EMBODIMENT

A method and apparatus for testing a Simple Object Access Protocol (SOAP) is described. In the following description, for purposes of explanation, numerous specific details are set forth in order to provide a thorough understanding of the present invention. It will be apparent, however, to one skilled in the art that the present invention may be practiced without these specific details In other instances, well-known structures and devices are shown in block diagram form in order to avoid unnecessarily obscuring the present invention.

Operational Overview

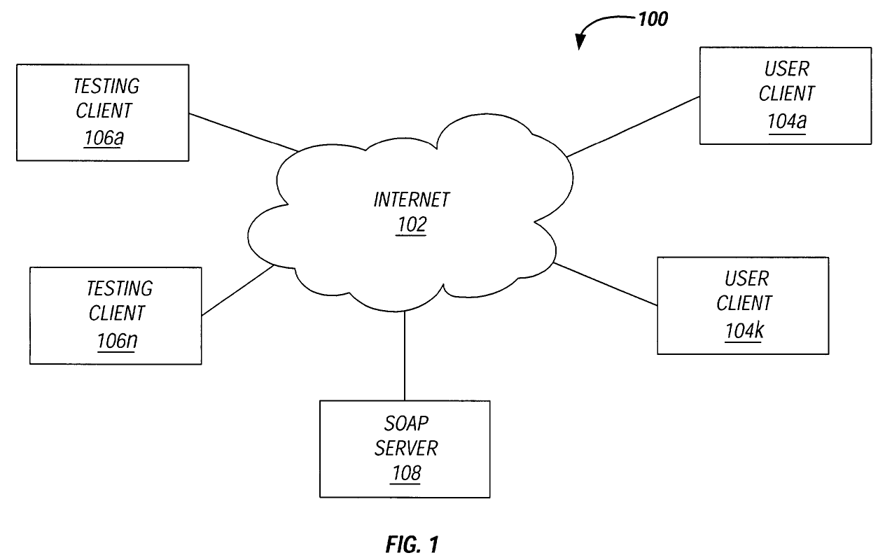

FIG. 1 is a block diagram that illustrates a computer system 100, including the Internet 102, a number of user clients 106a, 106n, a Simple Object Access Protocol (SOAP) server 108, and a number of testing clients 104a, and 104k.

There may be any number of user clients. However, only two of which are shown in FIG. 1 as user clients 104a and 104k. Similarly, there may be any number of testing clients. However, only two of which are shown in FIG. 1 as user clients 106a and 106n.

For purposes of explanation, assume that user client 104a is an accounting software application program. Further assume that SOAP server 108 is also a software application program that provides web services to perform currency exchange calculations that needed by the accounting software application program. User client 104a communicates with SOAP server 108 through Internet 102.

As an example, using Internet 102, user client 104a sends a request to convert X US dollars to British pounds. After, making the requested currency conversion calculation, SOAP Server 108 sends the results of the currency conversion to user client 104a.

Typically, web services such as those provided by SOAP server 108 are available to user clients on a 24/7 basis. Thus, there is a need to frequently test the operability of SOAP server 108 to ensure that SOAP server 108 continues to provide web services to customers such as user clients 104a, and 104k.

Testing clients 106a and 106n perform testing on SOAP server 108. Testing client 106a is a software application program that uses Simple Object Access Protocol (SOAP) when communicating with SOAP server 108 through Internet 102.

Testing clients use configuration files to repetitively test a given SOAP server according to an automatic scheduling for testing In certain embodiments of the invention, testing clients are called Monitors because they test and monitor SOAP servers.

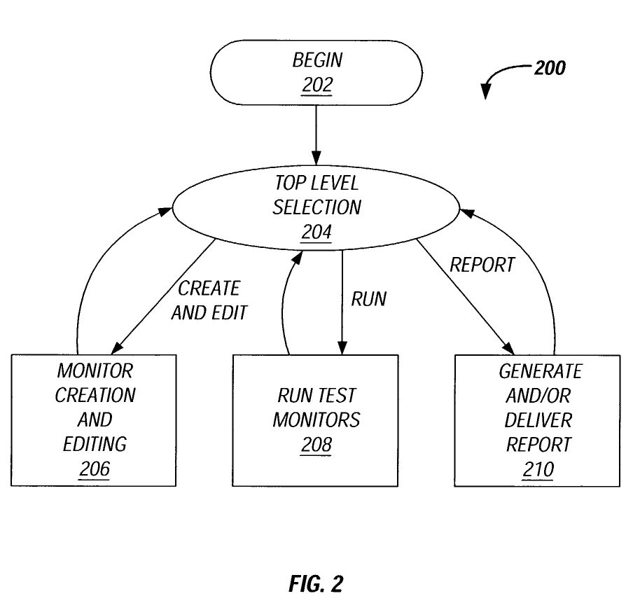

FIG. 2 is a flow diagram that illustrates a high level overview of one embodiment of a method for testing a SOAP server. The testing operation 200 begins at block 202 of FIG. 2. At block 204, a top-level selection of operations is made. At block 206, selection to create and edit a monitor may be made. At block 208, a selection to run monitors may be made. At block 210, a selection to generate and/or deliver reports of the testing may be made.

Monitors

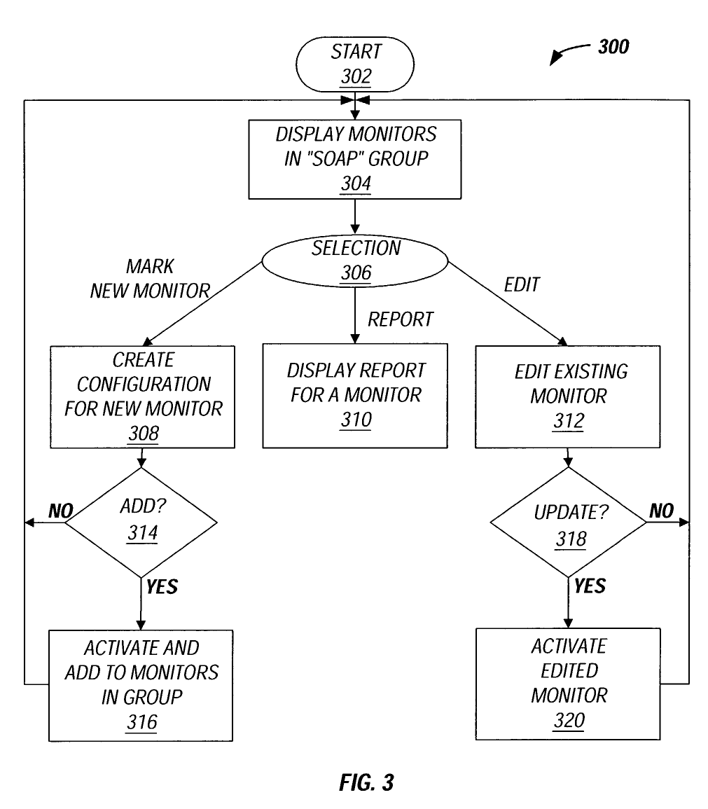

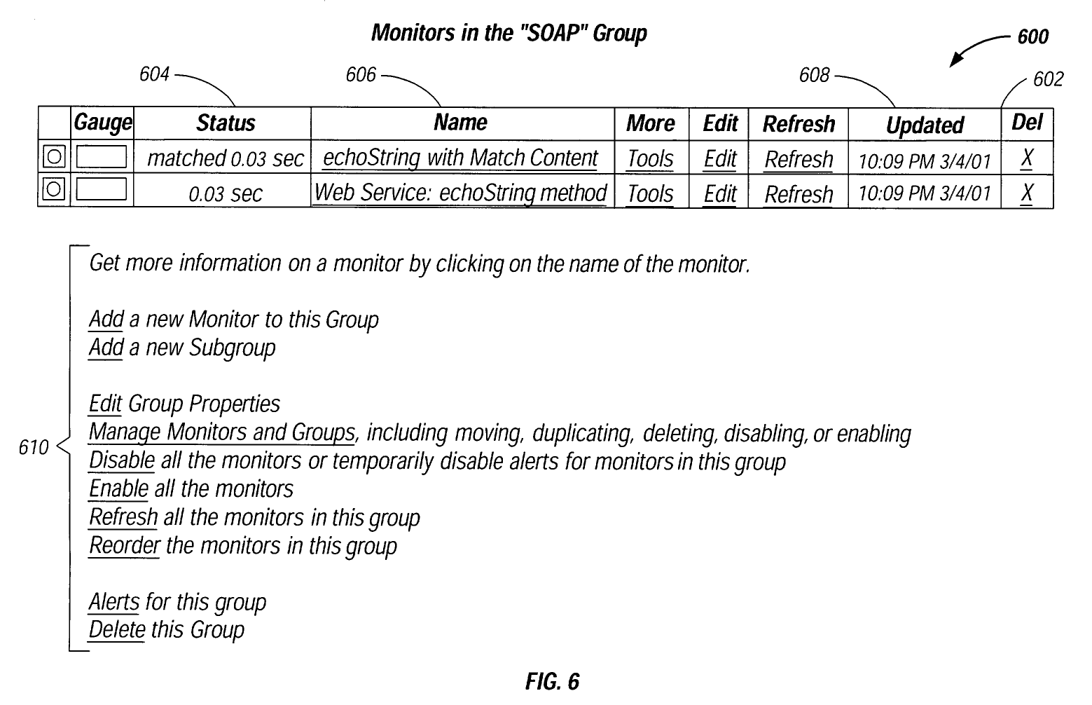

FIG. 3 is a flow diagram that illustrates the creation and editing of a monitor. Process 300 for creating or editing an existing monitor begins at block 302 of FIG. 3. At block 304, a mechanism displays the monitors in a given SOAP group. An example of such a display is illustrated in FIG. 6 as described herein.

At block 306, a selection of one operation is made. For example, if the operation to create a new monitor is selected, then at block 308, a configuration file for testing for a new monitor is created.

Once the configuration file for testing for the new monitor is created, then at block 314, a decision is made as to whether to add the new monitor. If it is decided to add the new monitor, then at block 316, the new monitor is activated and added to the monitors in the SOAP group.

If, however, it is decided not to add the new monitor to the monitors in the SOAP group, then control returns to block 304.

At block 306, it is possible to select a reporting operation. If it is decided that a reporting operation is to be selected, then at block 310, a mechanism allows an existing monitor from the SOAP group to be selected and displays the report that is associated with the selected monitor.

Further, at block 306, it is possible to select an editing operation. If it is decided that an editing operation is to be selected, then at block 312, a mechanism allows an existing monitor from the SOAP group to be selected for editing. At block 318, a decision is made as whether to accept the changes made during the editing process by an “update” operation If it is decided that the edited monitor is to be updated, then at block 320, the edited monitor is activated. Otherwise, if it is decided that the edited monitor is not to be updated, then control returns to block 304.

FIG. 6 is an illustration of a screen display of monitors in the SOAP group of FIG. 3. For purposes of simplicity, screen display 600 illustrates only one monitor in the SOAP group. Screen display 600 illustrates, among other things, table 602, and a list 610 of selectable options.

In table 602, column 606 contains the name of the monitors in the SOAP group. Column 604 contains the status of each monitor in the SOAP group. Column 608 shows the time when each monitor is updated.

List 610 is a list options for manipulating and managing the monitors in the SOAP groups. For example, the options for manipulating and managing the monitors include the following. 1) Add a new monitor to this group; 2) Add a new subgroup; 3) Edit group properties; 4) Manage monitors and groups, including moving, duplicating, deleting, disabling or enabling; 5) Disable all monitors, or temporarily disable alerts for monitors in this group; 6) Enable all monitors; 7) Refresh all monitors in this group; 8) Reorder the monitors in this group; 9) Alerts for this group; 10) Delete this Group.

Configuration Files

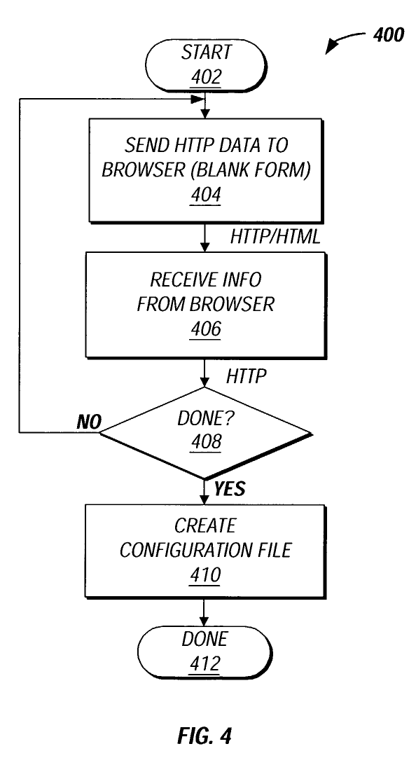

FIG. 4 is flow diagram that illustrates a process of creating a configuration file for testing. The process 400 of creating a configuration file for testing begins at block 402. At block 404, a blank form in HTTP format is sent to the browser of the IT professional who is developing the configuration file for testing. The IT professional fills out the blank form with information that is to be used for creating the configuration file for testing.

At block 406, the information from the IT professional is received from the browser. At block 408, it is determined whether all the information that is required for creating the configuration file for testing is received. If it is determined that all the information that is required for creating the configuration file for testing is received, then at block 410, a configuration file for testing is created to correspond to the new monitor that is to be added to the SOAP group. Otherwise, if it is determined that not all the information that is required for creating the configuration file for testing is received, then control returns to block 404 in order to solicit more information from the IT professional. Process 400 is complete at block 412.

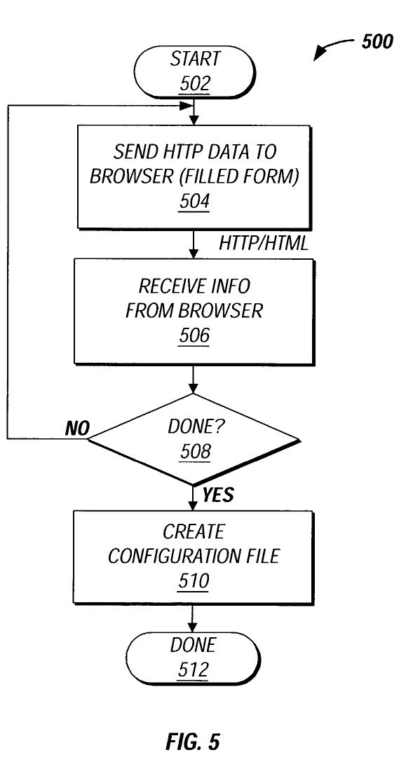

FIG. 5 is flow diagram that illustrates a process of editing and updating a configuration file for testing that corresponds to an existing monitor from the SOAP group. Process 500 for editing and updating a configuration file for testing that corresponds to an existing monitor from the SOAP group begins at block 502 of FIG. 5. At block 504, a filled form in HTTP format is sent to the browser of the IT professional who would like to edit the configuration file. The filled form contains information from the existing configuration file for testing corresponding to the monitor that is selected for updating. The IT professional edits the information on the filled form with changes that are to be used for updating the selected monitor.

At block 506, the edited information from the IT professional is received from the browser. At block 508, it is determined whether all the information that is required for creating the configuration file for testing is received. If it is determined that all the editing is complete, then at block 510, a new configuration file for testing is created to correspond to the updated monitor from the SOAP group. In other words, the monitor selected for updating is updated by creating, for the monitor selected for updating, a new configuration file using the edited information on the filled out form. Otherwise, if it is determined that the editing is not complete or if the editing is to be aborted then control returns to block 504. Process 500 is complete at block 512.

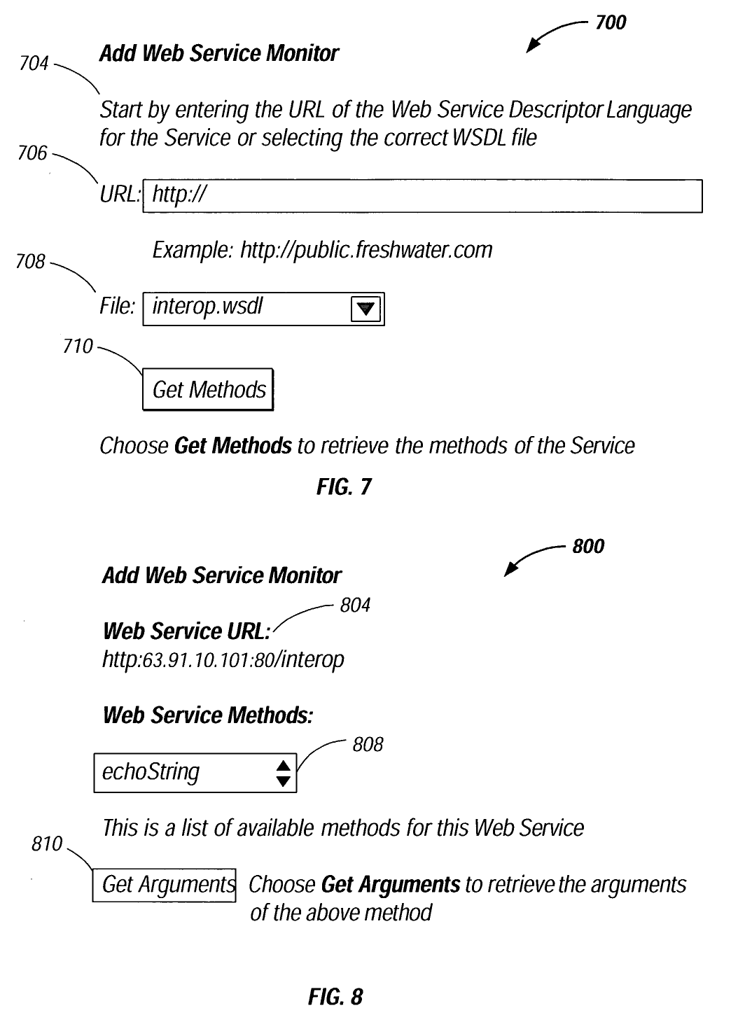

FIG. 7 is an illustration of a blank form used to develop the configuration file for testing of FIG. 4. For example, if the option, “add monitor” is selected in FIG. 6, then a blank form such as the one in FIG. 7 is provided for developing the configuration file for testing of FIG. 4.

Blank form 700 includes, among other features, instructions 704 for filling up the blank form in order to develop the configuration file for testing. URL 706 is a placeholder for entering the Uniform Resource Locator that gives the location of the appropriate Web Service Descriptor Language (WSDL) document that is associated with the desired web service. A WSDL document gives information on the web services that are available on the SOAP server. Typically, the WSDL file resides on the given SOAP server.

File 708 is a placeholder for entering the file name of the WSDL document. Button 710 is a “Get Methods” button. Button 710 is chosen if there is a desire to retrieve the methods of the web service.

FIG. 8 is also an illustration of a blank form used to develop the configuration file for testing of FIG. 4. In blank form 800, label 804 indicates the Web service URL of interest. Popup menu 808 gives a list of methods for the given web service. For example, “echostring” is a method that is available for the given web service. Button 810 is a “Get Arguments” button. Button 810 is chosen in order to retrieve the arguments to the method selected from popup menu 808. Information on the arguments is contained in the corresponding WSDL file.

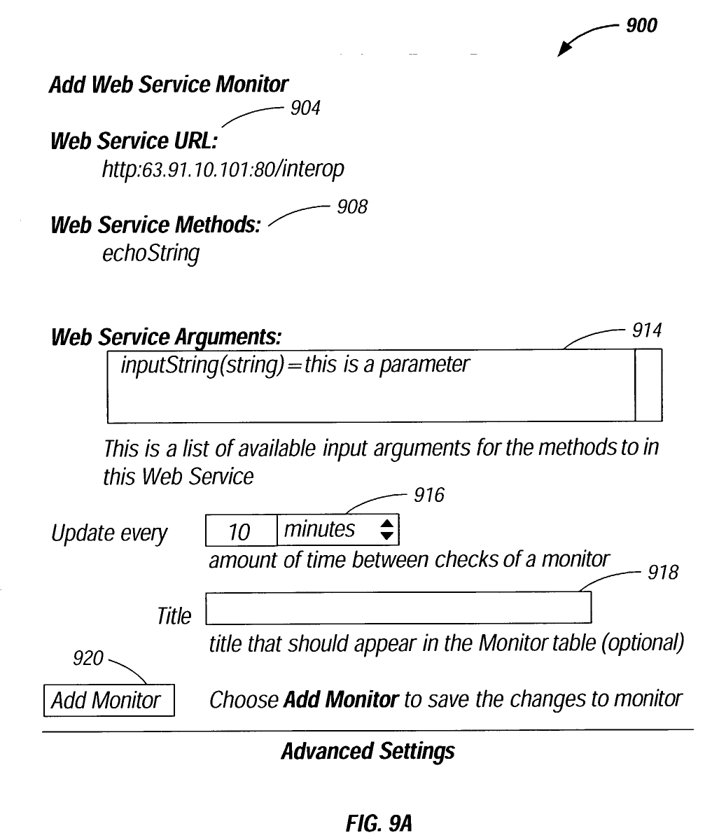

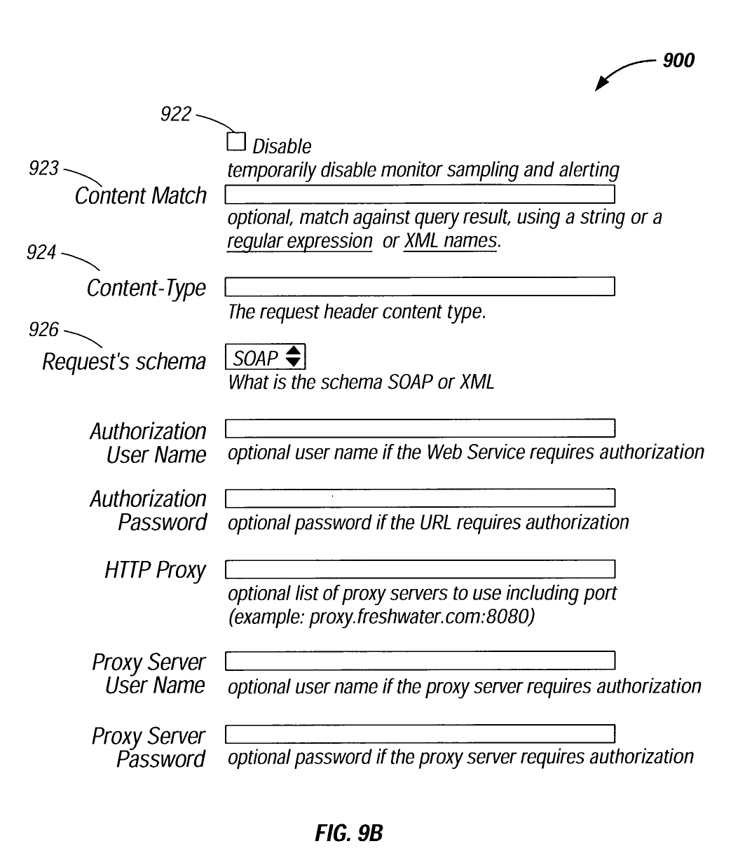

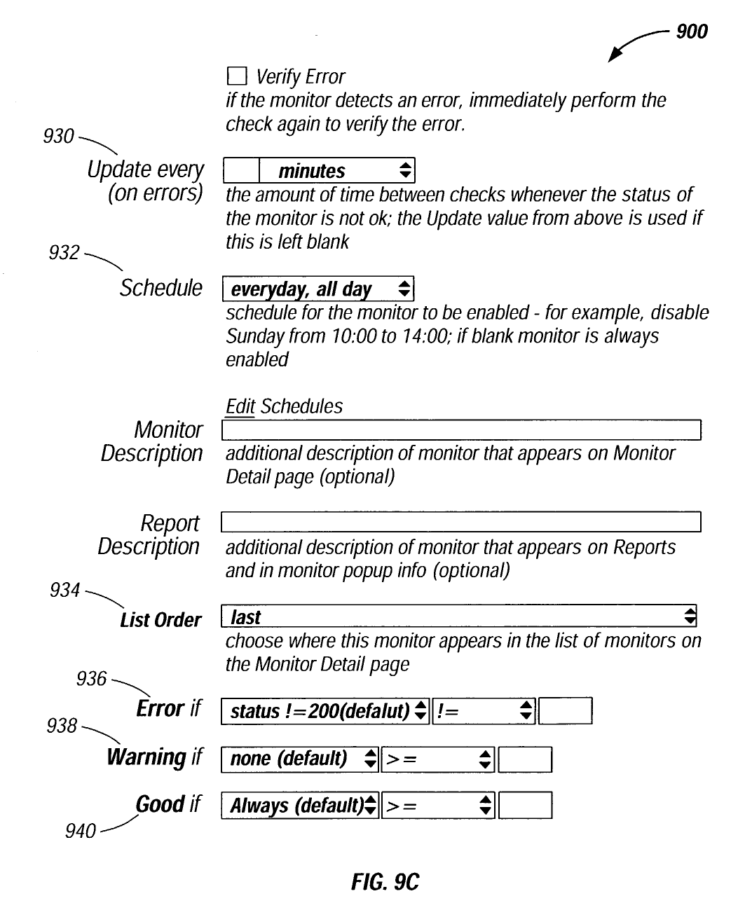

FIG. 9A is also a blank form used to develop the configuration file for testing of FIG. 4. In blank form 900, label 904 indicates the Web service URL of interest. Label 908 indicates the name of the Web service method of interest. Window 914 gives the arguments for the selected method of the given web service. Window 916 allows the specification of the frequency for checking the monitor that is to be added. Window 918 allows the input of a title for the monitor that is to be added. This title will appear as the name of the monitor in the table of monitors in the SOAP group, such as table 602 of FIG. 6. Button 920 is the button, “Add Monitor”. Button 920 is chosen in order to save the information that is entered thus far for the monitor that is to be added. The information that is entered thus far is used to make the configuration file that is associated with the monitor that is to be added.

FIG. 9B is a continuation of the blank form of FIG. 9A. Check box 922 is used if there is a desire to temporarily disable the sampling and alerting for the monitor to be added. Window 923 allows for input of content-match. Content-match is the response that is expected when a request is sent by this particular monitor (in this case, the monitor that is to be added) to the SOAP server. Window 924 allows for input of the content-type.

Window 926 allows for input of the schema of the request that can be sent by the monitor. The schema in this case is SOAP because the monitor that is to be added is a SOAP monitor.

FIG. 9C is a continuation of the blank form of FIG. 9B. Window 930 allows input of time between checks of the monitor whenever the status of the monitor indicates that the monitor is not in good order. The value that is input in window 916 of FIG. 9A is used as the default value if window 930 is left blank.

Window 932 allows for input of a schedule for enabling the monitor, i.e., for running a test on the SOAP server that provides the web services of interest. If window 932 is left blank, then the monitor is always enabled. Otherwise, specific times can be entered for disabling the monitor.

Window 934 allows a choice of the order in which the monitor appears in the list of monitors on the Monitor Detail page. Window 936 allows selection of conditions that trigger an error message. Window 938 allows selection of conditions that trigger a warning message. Window 940 allows selection of conditions that indicate that the monitor is in good operating condition

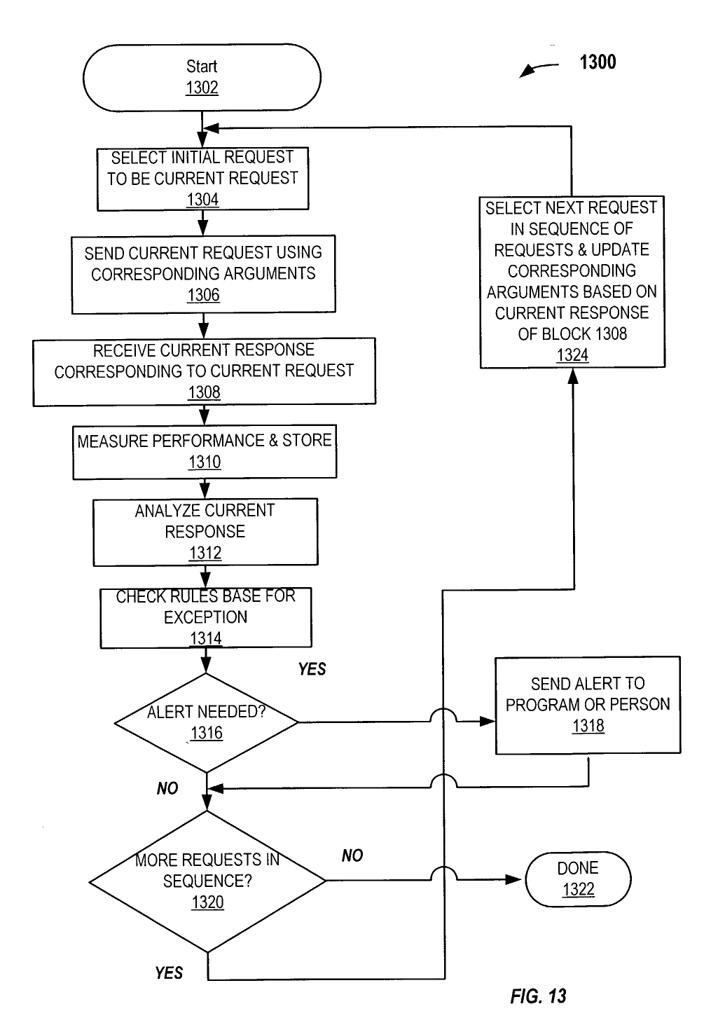

According to certain embodiments of the invention, the testing of a given SOAP server may involve sending a sequence of requests to the given SOAP server. In such cases, the response from an initial request is used to formulate the next request in the sequence of requests. Testing that involves sending a sequence of requests to a given SOAP server is explained in greater detail herein with respect to FIG. 13.

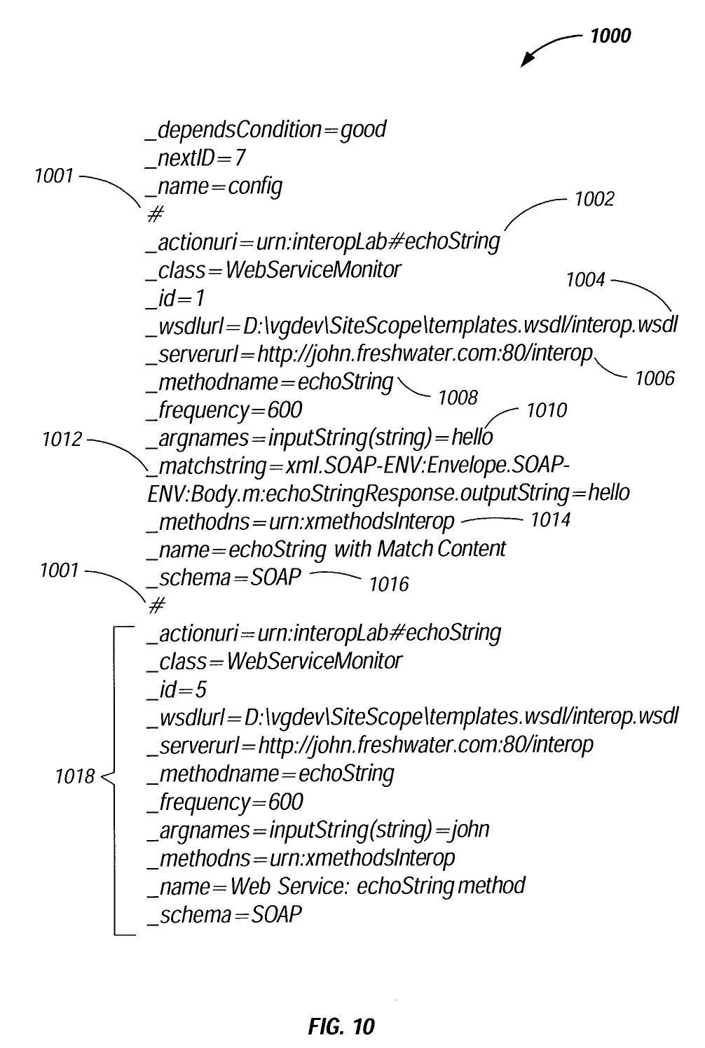

FIG. 10 is an exemplary form of a configuration file for testing. Configuration file 1000 comprises hatch marks 1001 that separate the information associated with each monitor. Action URI 1002 is the Uniform Resource Indicator that points to the actual request for sending to the SOAP server by the monitor. WSDL URL 1004 is the URL that points to the WSDL document that is associated with the monitor. Server URL 1006 is the URL that points to the SOAP server of interest.

Method name 1008 is the name of the method selected from the list of web services methods that are available. Argname 1010 is the input string that is part of the request sent by the monitor to the SOAP server. Match string 1012 is the response that can be expected corresponding to the request that is sent to the SOAP server. Match string is the value for content-match. Method NS 1014 indicates the namespace of the method selected from the web service. Schema 1016 is the schema of the request that is sent by the monitor to the SOAP server. Items in list 1018 correspond to information that is associated with the next monitor.

Testing Performed by Monitors

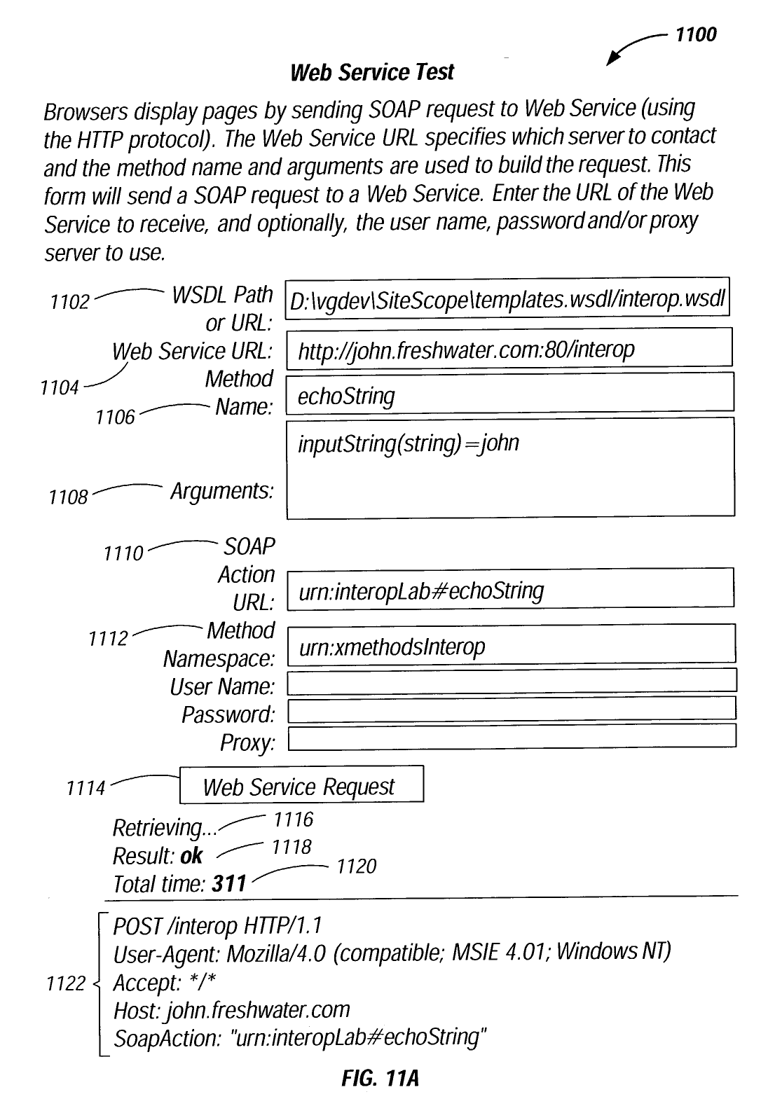

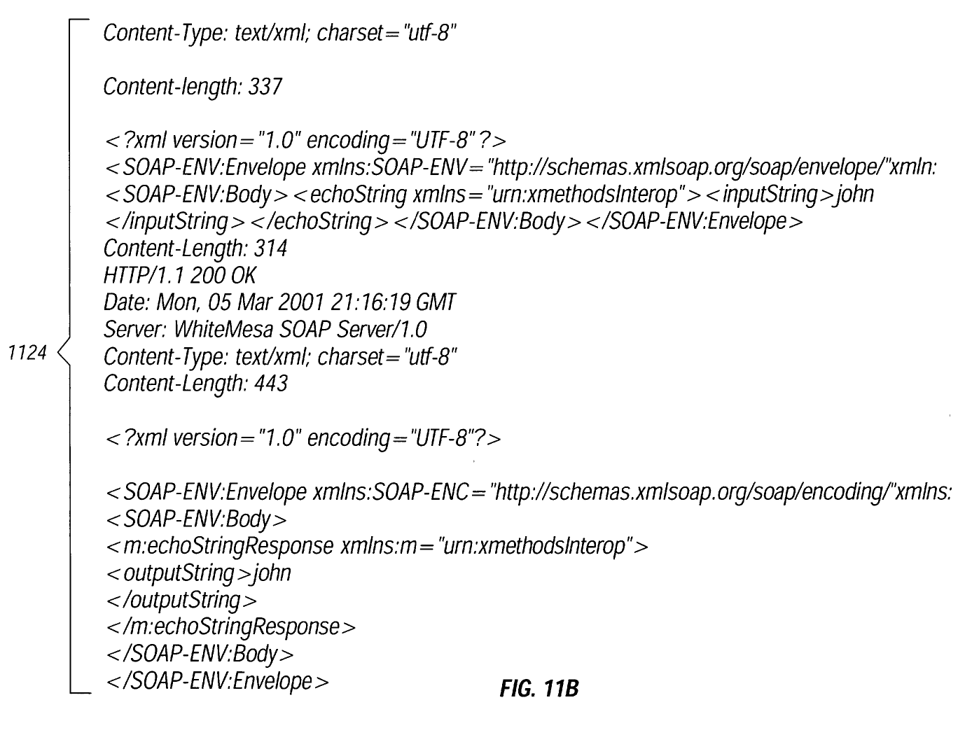

Testing of a given SOAP server is performed automatically by the monitor that corresponds to the given SOAP server. For purposes of explanation, the monitor that corresponds to the given SOAP server is referred to as the current monitor with reference to FIG. 11 and FIG. 12 and FIG. 13.

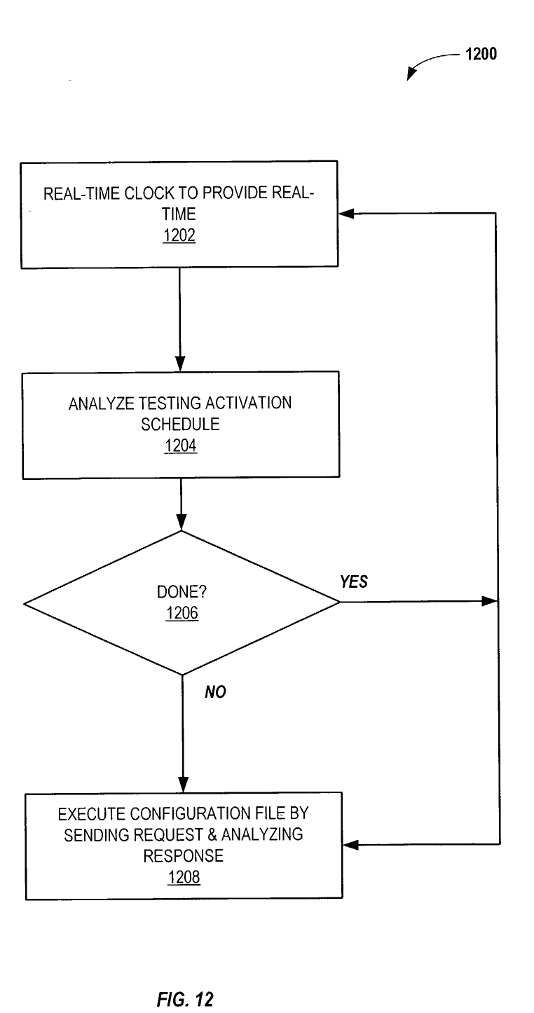

FIG. 12 is a flow diagram that illustrates the process of testing a SOAP server by running (i.e., executing) a monitor. Process 1200 of FIG. 12 begins at block 1202, where a real-time date and real-time hours, minutes and seconds are provided by a real-time clock and fed as an input to the operation at block 1204.

At block 1204, the activation schedule for testing to be performed by the current monitor is analyzed and compared to the input received from the real-time clock. At block 1206, it is determined whether testing is completed by the monitor. In other words, at block 1206 it is determined whether the execution of the appropriate configuration file for testing is completed. If so, process control returns to block 1202 to obtain a new real-time input. Otherwise, at block 1208, the configuration file is executed whereby a SOAP request is sent to the given SOAP server and the corresponding response that is received from the SOAP server is analyzed and the results stored in a log file.

According to certain embodiments of the invention, the testing of a SOAP server may involve sending a sequence of requests to the SOAP server. FIG. 13 is a flow diagram that illustrates the operations of sending a sequence of SOAP requests to a SOAP server, of receiving corresponding responses from the SOAP server, and of analyzing the responses.

Process 1300 of FIG. 13 begins at block 1302. At block 1304, an initial request is selected to be the current request. At block 1306, the current request with corresponding arguments are sent to the SOAP server.

At block 1308, the current response that corresponds to the current request is received. At block 1310, the performance of the SOAP server in satisfying the current request is measured and the measurements stored. At block 1312, the current response is analyzed. For example, the current response is checked against the expected response, i.e. content-match. The configuration file for testing contains information on the content of the expected response. At block 1314, it is determined whether there are any exceptions by comparing the current response against a rules base.

At block 1316, it is determined whether there are any alerts. If so, then the alert is sent to the relevant computer program or IT personnel at block 1318. If not, then at block 1320, it is determined whether there are any more requests in the sequence of requests. If not, then process 1300 is complete at block 1322. If it is determined that there are more requests in the sequence of requests, then at block 1324, the next request is selected from the sequence of requests is selected to be the current request and the corresponding arguments are updated based on the current response received at block 1308. Next, control is passed to block 1306. Thus, process 1300 continues until all the requests in the sequence of requests are sent to the SOAP server.

Reports of Soap Server Performance

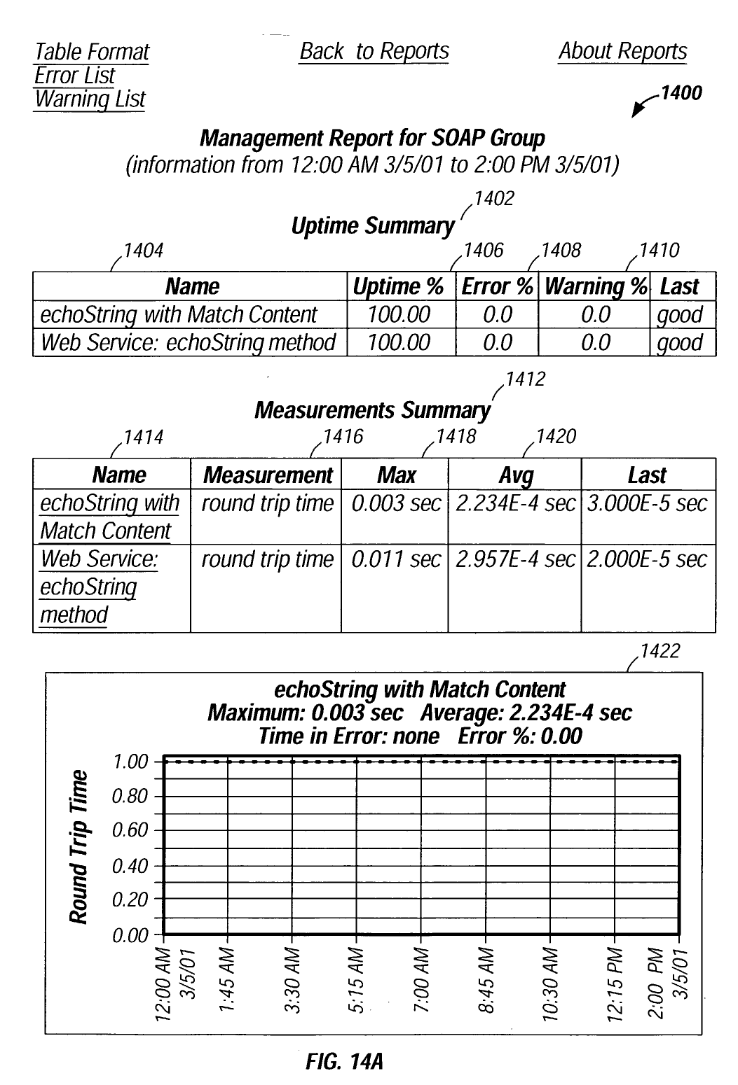

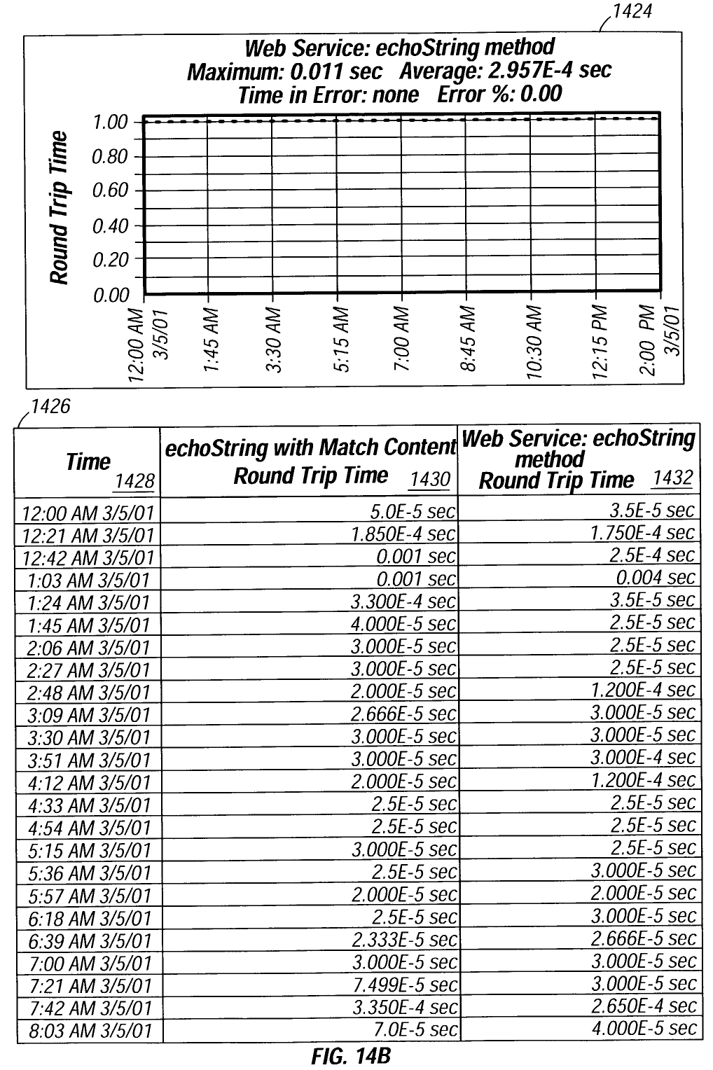

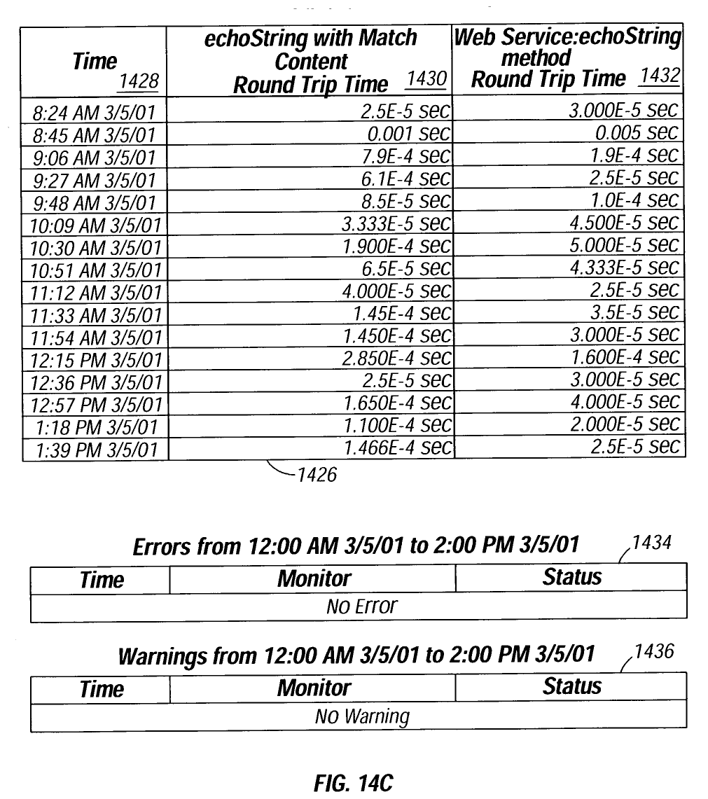

With reference to FIG. 2 and the operation of block 210, a given monitor in the SOAP group is capable of generating and delivering reports on the performance of the corresponding SOAP server that the monitor is testing. FIGS. 14A through 14C are exemplary reports that are generated by a given monitor.

In FIG. 14A, the management report 1400 for the SOAP group illustrates an Uptime Summary table 1402, a Measurements Summary table 1412, and a performance graph 1422.

Uptime Summary table 1402 comprises column 1404 that contains the name of the method, column 1406 that contains information on the percentage of time that the SOAP server is up and running, column 1408 that contains information on the percentage of errors that were detected, and column 1410 that contains the percentage of time that warnings were sent as part of the testing of the SOAP server.

Measurements Summary Table 1412 comprises column 1414 that contains the name of the method, column 1416 contains information on the type of measurement that is made, for example a round trip time versus a one-way trip time, column 1418 contains information on the maximum time for satisfying the request associated with a given method, column 1420 contains information on the average time for satisfying the request associated with a given method. The round trip time is the time it takes to send the request in addition to the time it takes to receive the corresponding response. Performance graph 1422 plots the round trip time against different times of the day when testing occurred for the echoString method with match content functionality The match content functionality is a method to determine whether the response matches the expected response.

FIG. 14B comprises a performance graph 1424, and a performance table 1426. Performance graph 1424 is a plot of the round trip time against different times of the day when testing occurred for the echoString method without measuring the time it takes to determine whether the response that is received matches the expected response. Performance graph 1424 plots the values of column 1432 against the values of 1428 of performance table 1426, which is described below.

Performance table 1426 comprises a testing time column 1428, the round-trip time of the echoString method with match content column 1430, and the round-trip time of the echoString method column 1432. Testing time column 1428 contains information on the different times at which the testing of the SOAP server occurred. The round-trip time of the EchoString method with match content column 1430 contains information on the round trip time it takes to send the request for the echoString method with match content functionality and receive the corresponding response. The round-trip time of the EchoString method column 1432 contains information on the round trip time it takes to send the request for the echoString method without match content functionality and receive the corresponding response.

FIG. 14C comprises the continuation of performance table 1426, error table 1434 and a warnings table 1436. Error table 1434 contains information related to any error messages that are generated during any of the testing periods. In this case, error table 1434 shows that there are no errors. Warnings table 1436 contains information related to any warning messages that are generated during any of the testing periods. In this case, warnings table 1434 shows that there were no warnings.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A method of testing a Simple Object Access Protocol (SOAP) server, the method comprising the computer-implemented steps:
automatically formulating a configuration file for testing;
using a software application program, wherein execution of said software application program is based on said configuration file for testing;
when said software application program is executed said software application program causes the computer-implemented steps comprising:
automatically sending a request to said SOAP server;
automatically receiving a response corresponding to said request;
automatically determining whether said response is an expected response; and
executing said application program according to an automatic scheduling for testing said Simple Object Access Protocol (SOAP) server.

2. The method as recited in claim 1, is performed by a first computer program.

3. The method as recited in claim 2, wherein said first computer program has direct Simple Object Access Protocol (SOAP) communication with said Simple Object Access Protocol (SOAP) server.

4. The method as recited in claim 1, wherein said Simple Object Access Protocol (SOAP) server is a second computer program.

5. The method as recited in claim 1, wherein the step of automatically formulating a configuration file for testing further comprises using an application interface.

6. The method as recited in claim 3, wherein the step of automatically formulating a configuration file for testing further comprises the steps:
sending a blank form in HTML format to a web browser, wherein said blank form solicits data that is used for testing said Simple Object Access Protocol (SOAP) server;
in response to sending said blank form, receiving said data from said web browser; and
developing said configuration file for testing based on said data.

7. The method as recited in claim 1, further comprises the computer-implemented steps of:
storing a result from the step of determining whether said response is said expected response; and
creating and delivering reports based on said result that is stored.

8. The method as recited in claim 1, further comprises the computer-implemented steps of:
storing a result from the step of determining whether said response is said expected response; and
displaying said result.

9. The method as recited in claim 1, further comprises sending an alert by comparing with a pre-determined set of criteria, a result from the step of determining whether said response is said expected response.

10. The method as recited in claim 1, wherein said configuration file for testing comprises said automatic scheduling for testing said Simple Object Access Protocol (SOAP) server.

11 A method of testing a Simple Object Access Protocol (SOAP) server, the method comprising the computer-implemented steps of.
automatically formulating a configuration file for testing;
automatically creating a monitor object from said configuration file for testing;
repetitively testing said Simple Object Access Protocol (SOAP) server by evoking said monitor object according to an automatic scheduling for testing Simple Object Access Protocol (SOAP) server.

12. A method of testing a Simple Object Access Protocol (SOAP) server, the method comprising the computer-implemented steps:
automatically formulating a configuration file for testing;
using a software application program, wherein execution of said software application program is based on said configuration file for testing;
when said software application program is executed, said software application program causes the computer-implemented steps comprising:
step A: automatically selecting a current request;
step B: automatically sending said current request;
step C: automatically receiving a current response corresponding to said current request;
step D: automatically determining whether said current response is an expected response;
step E: automatically selecting a next request to be a new current request based on said current response;
step F: automatically receiving a new current response corresponding to said new current request;
step G: automatically repeating steps E and F until a final response is received, wherein said final response matches a pre-determined final result; and
executing said software application program according to an automatic scheduling for testing said Simple Object Access Protocol (SOAP) server.

13. The method as recited in claim 12, is performed by a first computer program.

14. The method as recited in claim 13, wherein said first computer program has direct Simple Object Access Protocol (SOAP) communication with said Simple Object Access Protocol (SOAP) server.

15. The method as recited in claim 12, wherein said Simple Object Access Protocol (SOAP) server is a second computer program.

16. The method as recited in claim 12, wherein the step of automatically formulating a configuration file for testing further comprises using an application interface.

17. The method as recited in claim 14, wherein the step of automatically formulating a configuration file for testing further comprises the steps:
sending a blank form in HTML format to a web browser, wherein said blank form solicits data that is used for testing said Simple Object Access Protocol (SOAP) server;
in response to sending said blank form, receiving said data from said web browser; and
developing said configuration file for testing based on said data.

18. The method as recited in claim 12, further comprises the computer-implemented steps:
storing a result from the step of determining whether said current response is said expected response; and
creating and delivering reports based on said result that is stored.

19. The method as recited in claim 12, further comprises the computer-implemented steps
storing a result from the step of determining whether said current response is said expected response; and
displaying said result.

20. The method as recited in claim 12, further comprises sending an alert by comparing with a pre-determined set of criteria, a result from the step of determining whether said current response is said expected response.

21. The method as recited in claim 12, wherein said configuration file for testing comprises said automatic scheduling for testing said Simple Object Access Protocol (SOAP) server.

22. A computer-readable medium carrying one or more sequences of instructions for testing a Simple Object Access Protocol (SOAP) server, which instructions, when executed by one or more processors, cause the one or more processors to carry out the steps of:
automatically formulating a configuration file for testing;
using a software application program, wherein execution of said software application program is based on said configuration file for testing;
when said software application program is executed said software application program causes the computer-implemented steps comprising:
automatically sending a request to said SOAP server;
automatically receiving a response corresponding to said request;
automatically determining whether said response is an expected response; and
executing said application program according to an automatic scheduling for testing said Simple Object Access Protocol (SOAP) server.

23. A computer-readable medium carrying one or more sequences of instructions for testing a Simple Object Access Protocol (SOAP) server, which instructions, when executed by one or more processors, cause the one or more processors to carry out the steps of:
automatically formulating a configuration file for testing;
using a software application program, wherein execution of said software application program is based on said configuration file for testing;
when said software application program is executed, said software application program causes the computer-implemented steps comprising:
step A: automatically selecting a current request;
step B: automatically sending said current request;
step C: automatically receiving a current response corresponding to said current request;
step D: automatically determining whether said current response is an expected response;
step E: automatically selecting a next request to be a new current request based on said current response;
step F: automatically receiving a new current response corresponding to said new current request;
step G: automatically repeating steps E and F until a final response is received, wherein said final response matches a pre-determined final result; and
executing said software application program according to an automatic scheduling for testing said Simple Object Access Protocol (SOAP) server.
